(19) United States
(12) Patent Application Publication
(10) Pub. No.: US 2024/0358018 A1
(43) Pub. Date: Oct. 31, 2024

(54) METHOD FOR PROMOTING TILLERING OF GRAMINEOUS PLANTS

(71) Applicant: Hiizu SOMEI, Matsudo-shi (JP)

(72) Inventor: Hiizu SOMEI, Matsudo-shi (JP)

(21) Appl. No.: 18/596,149

(22) Filed: Mar. 5, 2024

(30) Foreign Application Priority Data
Apr. 25, 2023 (JP) 2023-071608

(51) Int. Cl. A01N 43/38; A01P 21/00

(52) U.S. Cl. CPC A01N 43/38; A01P 21/00

(57) ABSTRACT

This invention relates to a method for promoting tillering of gramineous plants comprising treating gramineous plants with a compound represented by Formula (I):

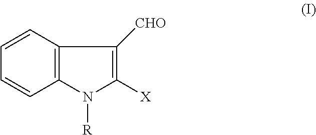

wherein R represents a hydrogen atom or a hydroxyl group; and X represents a halogen atom; or a salt thereof.

### CROSS REFERENCE TO RELATED APPLICATIONS

The present application claims priority from Japanese patent application JP 2023-071608 filed on Apr. 25, 2023, the content of which is hereby incorporated by reference into this application.

### BACKGROUND

### Technical Field

The present disclosure relates to a tillering promoter for gramineous plants.

### Background Art

The war in Ukraine triggered food insecurity worldwide. In Japan where the food self-sufficiency ratio is as low as 30%, approximately 60% of the nation's population is anticipated to die from starvation in 2030. This results from that Japan has relied on food imported from other countries and disregarded food production in its own country. Because Japan is a small country, it is necessary to increase food productivity and establish a technique of continuously increasing a crop yield.

Gramineous plants, such as rice plants, first undergo vegetative growth after seedlings and the like are planted and then advance to the tillering stage at which fresh stems emerge from the bases of seedlings. Subsequently, reproductive growth advances in sequence from the panicle formation stage, the boot stage, the ear emergence/flowering stage, to the mature stage, rice stalks grow, and rice plants then become harvestable. Stem development at the tillering stage is classified as productive tillering or non-productive tillering. The term “productive tillering” refers to development of stems (lateral shoots) that develop seeding stalks as the reproductive growth advances. The term “non-productive tillering” refers to development of stems (lateral shoots) that do not develop stalks or that develop stalks without seeds.

As the productive tillering number increases, the number of seeds per strain increases. Accordingly, productive tillering is a factor that significantly influences an increase or decrease in the yield.

In order to promote productive tillering and increase the yield, use of growth regulators, such as fertilizers or plant hormones, has been attempted, although the effects thereof are not sufficient.

Techniques of promoting tillering of gramineous plants have been disclosed. For example, JP Patent No. 5,866,035 discloses a method for promoting productive tillering comprising treating gramineous plants with the superheated steam-treated microbial material, which is obtained by treating a mixture containing yeast, phosphoric acid, potassium, and the like with superheated steam, JP 2020-83853 A (e.g., claim 9) discloses a tillering promoter for gramineous plants, comprising a particular strigolactone biosynthesis inhibitor, and WO 2018/159835 (e.g., claim 6) discloses a tillering promoter for gramineous plants, comprising a particular strigolactone receptor inhibitor.

The 2-halo-indole-3-carbaldehydes described in the literatures (M. Somei, Indole chemistry for combating yellow sand and desertification directed towards stopping global warming, Heterocycles, 82 (No. 2), 1007-1027, 2011; Masanori Somei, Challenge to desert greening to prevent yellow sand and stop global warming, Koryouikikyoiku, 70, 4-11, 2008; Masanori Somei, “SOMRE”, a Growth Regulator ‘Medicine’ for the Earth to Increase Food Production and to Stop Global Warming, Japan Sea Research, 45, 105-120, 2014; K. Naik, S. Mishra, M. Somei, R. Awano, H. Srichandan, P. K. Singh, T. Mohapatra & J. P. Soren; Effect of a root growth promoter on selected crops grown in India, Plant Physiology Reports, 2020, 25(2), 284-297; Masanori Somei, Imagination and Creation: 1-Hydroxyindole Chemistry and the Dream Challenge, Yakugaku Zasshi (Journal of the Pharmaceutical Society of Japan), 128 (4), 527-563, 2008; and T. Kawasaki, M. Tabata, K. Nakagawa, K. Kobayashi, A. Kodama, T. Kobayashi, M. Hasegawa, K. Tanii, and M. Somei, Simple synthetic method for 1-hydroxyindole and its application to 1-hydroxytryptophan derivatives, Heterocycles, 90, 1038-1071, 2015) are reported to allow local plants to grow in the Gobi Desert in China with the selective use of natural rainfall as the water resource without the provision of irrigation facilities or application of ground water and contribute to desert greening and yellow sand prevention, exert elongation effects on the roots of plants such as rice and cucumber, improve the survival rate, and contribute to environmental greening (M. Somei, Indole chemistry for combating yellow sand and desertification directed towards stopping global warming, Heterocycles, 82 (No. 2), 1007-1027, 2011; Masanori Somei, Challenge to desert greening to prevent yellow sand and stop global warming, Koryouikikyoiku, 70, 4-11, 2008; Masanori Somei, “SOMRE”, a Growth Regulator ‘Medicine’ for the Earth to Increase Food Production and to Stop Global Warming, Japan Sea Research, 45, 105-120, 2014; and K. Naik, S. Mishra, M. Somei, R. Awano, H. Srichandan, P. K. Singh, T. Mohapatra & J. P. Soren; Effect of a root growth promoter on selected crops grown in India, Plant Physiology Reports, 2020, 25(2), 284-297). However, there have been no reports on activity of promoting tillering of gramineous plants.

### SUMMARY

The present disclosure relates to a tillering promoter for gramineous plants with high safety that minimizes the amount of agricultural chemicals or fertilizers to be used and contributes to increased production of gramineous plants without genetic engineering.

The present disclosure is summarized as follows.

(1) A tillering promoter for gramineous plants comprising a compound represented by Formula (I):

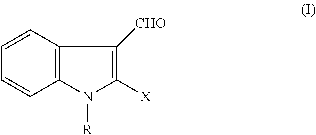

wherein R represents a hydrogen atom or a hydroxyl group; and X represents a halogen atom; or a salt thereof.
(2) A method for promoting tillering of gramineous plants comprising treating gramineous plants with the tillering promoter for gramineous plants according to (1).

According to the present disclosure, tillering of gramineous plants is promoted, and the number of seeds developed per strain is increased. This can increase the yield of gramineous plants.

### BRIEF DESCRIPTION OF THE DRAWINGS

FIG. 1 shows photographs demonstrating the conditions at the time of planting (A) and the conditions of the satisfactorily growing plants (B) observed in Example 3.

FIG. 2 shows photographs demonstrating the conditions at the time of harvesting (A), rice stalks of the groups (B), and rice stalks untangled and spread out one by one (C) observed in Example 3.

FIG. 3 shows photographs demonstrating a comparison of the amounts of the rice seeds that were actually harvested (A) and a comparison of the amounts of hulled rice after threshing (B) observed in Example 3.

FIG. 4 shows a photograph demonstrating the results of the rice growing projects performed in Example 4.

### DETAILED DESCRIPTION

Examples of halogen atoms represented by X in Formula (I) include a chlorine atom, a bromine atom, and an iodine atom.

An example of a compound represented by Formula (I) is a compound shown below.

| | | | (I) |
|---|---|---|---|
| 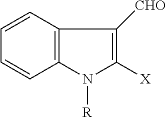 | | | |
| SOMRE | | | |
| Number | | R | X |
| No. | 1 | H | Br |
| | 2 | H | Cl |
| | 3 | H | I |
| | 4 | OH | Br |
| | 5 | OH | Cl |
| | 6 | OH | I |

Examples of salts of the compound represented by Formula (I) include: salts of inorganic acids, such as hydrochloric acid, sulfuric acid, phosphoric acid, hydrobromic acid, hydriodic acid, nitric acid, pyrosulfuric acid, and metaphosphoric acid; and salts of organic acids, such as citric acid, benzoic acid, acetic acid, propionic acid, fumaric acid, maleic acid, and sulfonic acid (e.g., methanesulfonic acid, p-toluenesulfonic acid, or naphthalenesulfonic acid).

The compound represented by Formula (I) is a known compound. For example, it can be produced in accordance with the methods described in M. Somei, Indole chemistry for combating yellow sand and desertification directed towards stopping global warming, Heterocycles, 82 (No. 2), 1007-1027, 2011; Masanori Somei, Imagination and Creation: 1-Hydroxyindole Chemistry and the Dream Challenge, Yakugaku Zasshi (Journal of the Pharmaceutical Society of Japan), 128 (4), 527-563, 2008; or T. Kawasaki, M. Tabata, K. Nakagawa, K. Kobayashi, A. Kodama, T. Kobayashi, M. Hasegawa, K. Tanii, and M. Somei, Simple synthetic method for 1-hydroxyindole and its application to 1-hydroxytryptophan derivatives, Heterocycles, 90, 1038-1071, 2015.

In general, the compound represented by Formula (I) is used in the form of a 1.0 ppm to 1.0 ppb aqueous solution.

In general, plant seeds or roots are soaked in the aqueous solution. A soaking period may generally be for 1 hour. Hard-coated seeds may be soaked in the aqueous solution for 1 day to several days, so as to be impregnated with the aqueous solution. The soaked seeds and the seedlings, the roots of which had been soaked, are removed from the solution and planted in the fields or farmlands. The subsequent procedure may be performed in accordance with a conventional cultivation technique. In particular, use of agricultural chemicals or fertilizers is not necessary. This enables construction of a food production system with the highest safety and prevention of farmlands or the environment from contamination with agricultural chemicals. While a concentration of the aqueous solution adequate for soaking the seeds or roots varies depending on plant types, in general, a concentration may be approximately 1.0 ppm. A method of foliar application may be employed.

Target plants of the present disclosure are not particularly limited, provided that such plants are gramineous plants. Examples thereof include rice, Japanese millet, corn, foxtail millet, millet, and sorghum.

### EXAMPLES

Hereafter, the present disclosure is described in greater detail with reference to the examples, although the present disclosure is not limited to these examples.

In the examples below, among the 2-halo-indole-3-carbaldehyde compounds represented by Formula (I) used in the present disclosure, a typical compound represented by Formula (I), wherein R represents a hydrogen atom; and X represents a bromine atom, was used (hereafter, such compound is referred to as “SOMRE No. 1”).

### (Example 1) Method for Use of “SOMRE No. 1”

(1) “SOMRE No. 1” crystal was dissolved in water to prepare a 1.0 ppm aqueous solution of “SOMRE No. 1.” Subsequently, the solution was diluted to 10-fold, 100-fold, and 1,000-fold with water to prepare 0.1 ppm, 0.01 ppm, and 0.001 ppm aqueous solutions of “SOMRE No. 1.”
(2) Plant seeds or roots were soaked in the aqueous solution of “SOMRE No. 1.” A soaking period may generally be for 1 hour. Hard-coated seeds need to be soaked for 1 day to several days, so as to be impregnated with the solution of SOMRE No. 1.
(3) The soaked seeds and the seedlings, the roots of which had been soaked, were removed from the solution and planted in the fields or farmlands. The subsequent procedure may be performed in accordance with a conventional cultivation technique.
(4) A concentration of the aqueous solution of “SOMRE No. 1” adequate for soaking the seeds or roots varies depending on plant types. In general, a concentration may be approximately 1.0 ppm.

### (Example 2) Discussion: Elucidation of a Mechanism for Increasing Food Yield

Gramineous plants have the tillering (branching) capacity, which increases new branches. Depending on the extent of branching, the number of flowers or fruits increases, and, as a consequence, the food yield increases. If the tillering activity is too high, the number of branching increases, which slows rooting and root growth. This results in the deconcentrated growth of plants and the decreased number of fruits or stalks. In addition, the size of flowers or fruits becomes smaller, the yield decreases, and the quality and the taste deteriorate.

The 2-halo-indole-3-carbaldehyde compounds represented by Formula (I) have the tillering activity and such compounds also have the activity of developing and elongating the branched roots. Accordingly, thickening and growth of the roots of tiller branches are promoted, and the growth is adequately controlled. This increases the number of fruits or stalks, the size of flowers or fruits, and the yield.

### Example 3

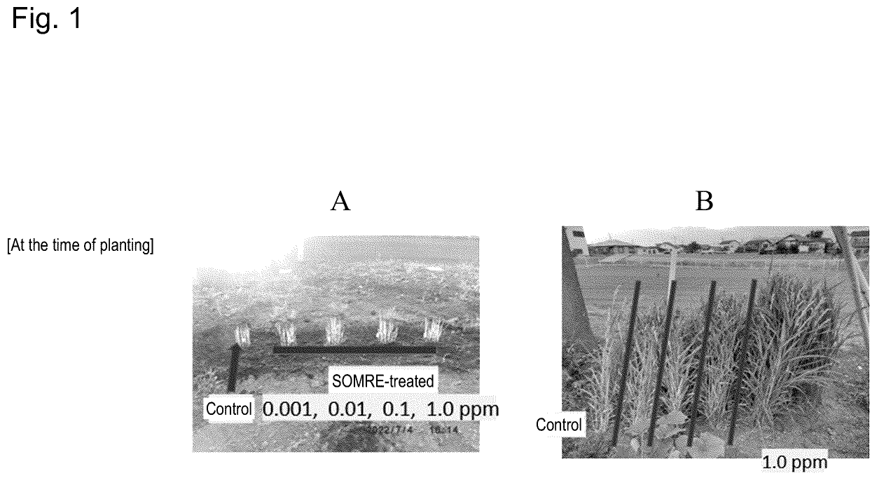

Rice plants: Rice seeds of the Japanese Upland Rice Variety Norin 1 (upland glutinous rice seeds) were divided into groups each consisting of 29 seeds, and the seeds were soaked in water and 1.0 ppm to 0.001 ppm aqueous solutions of SOMRE No. 1 for one day and night to grow seedlings. Thereafter, the grown seedlings of each group were separately planted in the fields as shown in FIG. 1 A. The conditions of the satisfactorily growing plants are shown in FIG. 1 B.

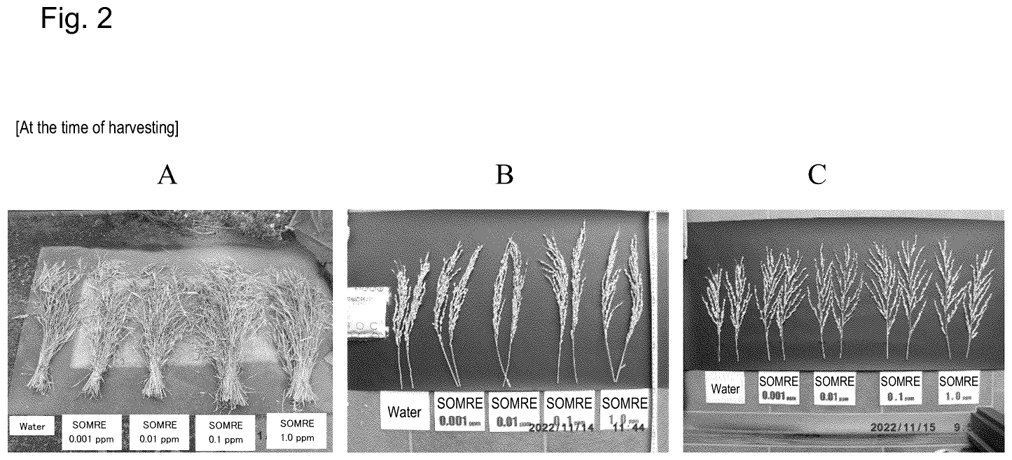

FIG. 2 A shows a photograph demonstrating the conditions at the time of harvesting. FIG. 2 B shows a photograph demonstrating rice stalks of the groups. FIG. 2 C shows a photograph demonstrating rice stalks untangled and spread out one by one, so as to observe the extent of bearing. The photographs demonstrate that the yield of the sample treated with SOMRE No. 1 is higher at any concentration, compared with that of the control (treated with water).

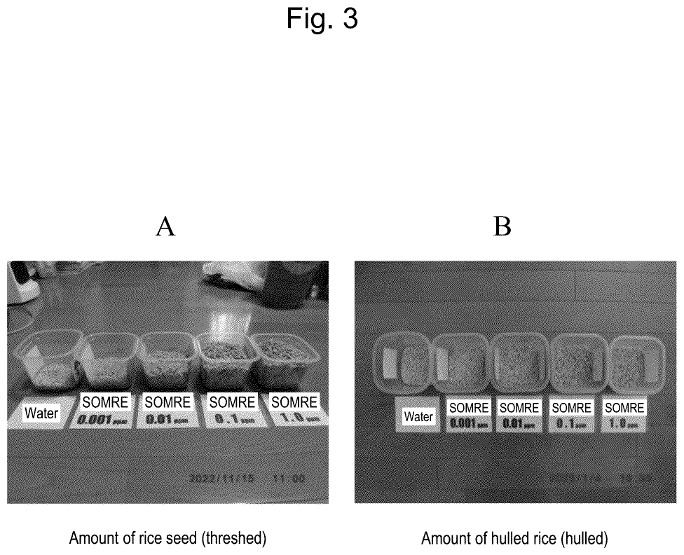

FIG. 3 A shows a photograph demonstrating a comparison of the amounts of the threshed rice seeds that were actually harvested. FIG. 3 B shows a photograph demonstrating a comparison of the amounts of hulled rice after threshing.

The results demonstrated above are summarized in Table 1. The total weight of the control threshed rice seeds and that of the hulled rice were 57.1 g and 42.5 g, respectively. When the rice seeds were treated with SOMRE No. 1, the yield increased as the concentration of SOMRE No. 1 increased. The weights of the samples treated with a 1.0 ppm aqueous solution of SOMRE No. 1 were 246.4 g and 186.3 g, respectively. When the weight of the control hulled rice was designated as 100%, the weight of the sample treated with a 1.0 ppm aqueous solution of SOMRE No. 1 was 438%. This indicates a significant increase in the yield.

TABLE 1

| | Control | SOMRE | SOMRE | SOMRE | SOMRE |
|---|---|---|---|---|---|
| | (water) | 0.001 ppm | 0.01 ppm | 0.1 ppm | 1.0 ppm |
| Weight of rice | 57.1 | 105.8 | 144.1 | 220.5 | 246.4 |
| seeds (g) | | | | | |
| (threshed) | | | | | |
| Weight of | 42.5 | 75.6 | 103.7 | 159.4 | 186.3 |
| hulled rice | | | | | |
| (g) (hulled) | | | | | |
| Comparison of | 100 | 178 | 244 | 375 | 438 |
| total weight of | | | | | |
| hulled rice (g) | | | | | |

In order to inspect the cause of the yield increase, branching of the stalks; i.e., the tillering number, was inspected. As a result, the tillering number of the control samples was 79, that of the samples treated with a 0.001 ppm aqueous solution of SOMRE was 91, and that of the samples treated with 0.01 ppm, 0.1 ppm, and 1.0 ppm aqueous solutions of SOMRE was 111, 143, and 162, respectively. Specifically, tillering increased the number of newly branched stalks, the newly grown stalks developed roots, and healthy rice plants have grown. This indicates that the increased number of rice stalks results in the increased amount of the rice seeds.

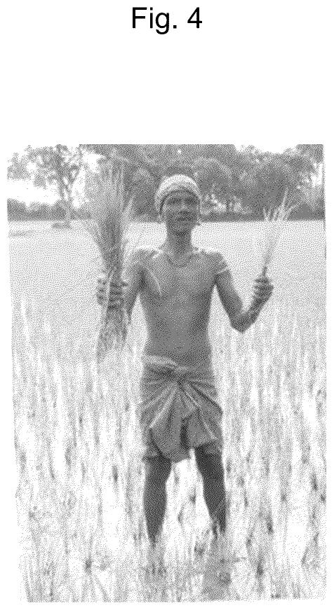

(Example 4) Paddy-field rice plant, rice Basic experiment had been performed for 4 years by joint researchers, Mr. Awano and the Dr. Mishra' laboratory, KIIT University, India. FIG. 4 shows a photograph demonstrating the results of the rice growing projects performed to solve the problem of famine on the basis of the aforementioned results with cooperation from the government and researchers of agriculture of India since 2015. As shown in FIG. 4, the number of the “SOMRE No. 1”-treated stalks grabbed by the right hand of the farmer is larger than that of the control stalks grabbed by the left hand. This clearly indicates the effects of tillering for increasing the stalks. In addition, roots of new stalks grow close together, and healthy rice plants grow. This increases the number of rice stalks and improves productivity. FIG. 4 shows the evidence thereof.

The rice output in India is generally 5,100 kg/1 ha. When rice seeds were treated with 1.0 ppm and 0.1 ppm aqueous solutions of “SOMRE No. 1” and grown, however, the rice output of 6,511 kg/1 ha and that of 6,833 kg/1 ha were achieved, respectively. When the output of the control was designated 100%, the harvest yields achieved as a result of treatment with 1.0 ppm and 0.1 ppm aqueous solutions of “SOMRE No. 1” were as high as 127% and 134%, respectively. This indicates an increased yield. Also, the sugar content of the rice treated with a 0.1 ppm aqueous solution of “SOMRE No. 1” was measured to be 0.5%. This indicates that rice with improved quality and a better taste can be produced.

According to the data on “the yield and harvesting of paddy field/upland rice plants by growing seasons on the fiscal year 2018” provided by the Ministry of Agriculture, Forestry and Fisheries, Japan (the Ministry of Agriculture, Forestry and Fisheries, Japan, 2018a), the rice harvest yield in Japan is 5,300 kg/1 ha. This indicates that the outcome superior to that in Japan can be achieved by additionally performing a step of soaking rice seeds in a 0.1 ppm aqueous solution of “SOMRE No. 1.”

### (Example 5) Corn

In the experiment performed with the use of corn, the optimal concentration of an aqueous solution of “SOMRE No. 1” was different because of a difference in the variety, and the results shown in Table 2 were obtained.

TABLE 2

| | Optimal SOMRE | | |
|---|---|---|---|
| Variety | concentration | | Results |
| Pure White | 0.000001 ppm | | 2-fold yield compared to the control |
| | (1.0 ppb) | | |
| Gold Rush | 0.1 | ppm | 1.5-fold yield compared to the control |
| Honey Bantam | 0.001 | ppm | 2.0-fold yield compared to the control |

### (Test Example) Safety Test

In general, the 2-halo-indole-3-carbaldehyde compounds represented by Formula (I) are used in the form of a 1.0 ppm to 1.0 ppb aqueous solution. Accordingly, safety thereof was examined using SOMRE at the highest concentration in the form of the 1.0 ppm aqueous solution.

(Safety of Aqueous Solution of SOMRE No. 1 (1.0 ppm))

### (1) Safety for Fish

Japanese killifish was raised in an aqueous solution of SOMRE No. 1 (1.0 ppm). Japanese killifish grows steadily for 2 years and 2 months after the initiation of the experiment. The length of the body is longer and the waist circumference is larger than the initial sizes. Since the growth of Japanese killifish, which is sensitive to toxic substances, was not affected at all, the aqueous solution of SOMRE No. 1 (1.0 ppm) was determined to have very high safety.

### (2) Safety for Animals (Rabbits, Mice, Goats, and Insects)

Plants grow from seeds treated with the aqueous solution of SOMRE No. 1 (1.0 ppm), and such plants play a key role in greening of the Gobi Desert in China. At the germination stage and the seedling stage, buds, stems, and roots were suitable food for rabbits, mice, goats, and insects, the plants were eaten thereby, and the survival rate dropped to 87.6%. However, such survival rate was much better than the highest survival rate (78.3%) achieved by Chinese researchers. Under such circumstances, no dead rabbits, mice, or insects were found. That is, the aqueous solution of SOMRE No. 1 (1.0 ppm) was determined to have very low toxicity.

### (3) Safety for Animals (Goats)

In the Gobi Desert, SOMRE No. 1 was mixed with feeds in an amount comparable to the aqueous solution of SOMRE No. 1 (1.0 ppm) and administered to cashmere goats over a period of 1 year. Healthy goats grew, and a larger quantity of longer cashmere hair was produced compared with usual cashmeres. A level of breeding activity was high, and healthy baby goats grew. Reproducibility was observed over a period of 4 years. That is, safety of SOMRE No. 1 was determined to be very high.

### (4) Safety for Humans

### (a) Skin

In the Gobi Desert greening project, 15 males and females were subjected to soaking of seeds in aqueous solutions of SOMRE No. 1 (1.0 ppm) for 4 hours. During the soaking, both hands were continuously soaked in the aqueous solutions of SOMRE No. 1 (1.0 ppm). Because of the nature of the desert, there was no water to wash hands, they dried their hands without washing, they went home in that state, and they then went back to their daily life. None of them found any abnormality on the skin a week thereafter. Accordingly, the aqueous solutions of SOMRE No. 1 (1.0 ppm) was determined to have very high safety on the skin.

### (b) Body

(i) In the Gobi Desert greening project, working in the sand dunes makes the workers thirsty. Accordingly, each person drank 500 ml of the aqueous solutions of SOMRE No. 1 (1.0 ppm) every day for 3 days. This did not make any change in their physical conditions.
(ii) A person drank 100 ml of the aqueous solutions of SOMRE No. 1 (1.0 ppm) at home every day for 1 year. The person did not find any influence on health conditions.

The results described above demonstrate that SOMRE No. 1 is safe for humans, animals, fish, and the like.

All publications, patents, and patent applications cited in this application are intended to be incorporated herein by reference in their entirety.

What is claimed is:

1. A method for promoting tillering of gramineous plants comprising treating gramineous plants with a compound represented by Formula (I): 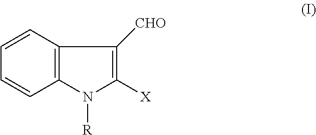
wherein R represents a hydrogen atom or a hydroxyl group; and X represents a halogen atom; or a salt thereof.
